(19) United States
(12) Patent Application Publication
(10) Pub. No.: US 2016/0098331 A1
(43) Pub. Date: Apr. 7, 2016

(54) METHODS FOR FACILITATING HIGH AVAILABILITY IN VIRTUALIZED CLOUD ENVIRONMENTS AND DEVICES THEREOF

(71) Applicant: NetApp, Inc., Sunnyvale, CA (US)

(72) Inventors: Deepti Banka, Ghaziabad (IN); Ameya Prakash Usgaonkar, Old Goa (IN); Bhaskar Singhal, Bangalore (IN)

(21) Appl. No.: 14/508,372

(22) Filed: Oct. 7, 2014

(51) Int. Cl. G06F 11/20

(52) U.S. Cl. CPC G06F 11/2092; G06F 2201/805; G06F 2201/815

(57) ABSTRACT

A method, non-transitory computer readable medium and host computing device that stores, by a first virtual storage controller, a plurality of received transactions in a transaction log in an in-memory storage device. The first virtual storage controller is monitored and a determination is made when a failure of the first virtual storage controller has occurred based on the monitoring. When the failure of the first virtual storage controller is determined to have occurred, at least one storage volume previously assigned to the first virtual storage controller is remapped to be assigned to a second virtual storage controller. Additionally, the second virtual storage controller retrieves at least one of the transactions from the transaction log in the in-memory storage device and replays at least one of the transactions.

### FIELD

This technology relates to failover in data storage networks, and more particularly to methods and devices for providing high availability storage on virtual or cloud data storage platforms.

### BACKGROUND

A storage fabric may include multiple storage controllers, including physical and/or virtual storage controllers, which store and manage data on behalf of clients. Clients with applications utilizing such a storage fabric rely on continuous data availability. Accordingly, one common technique to provide high availability is to cross wire storage drives or fabric between two physical storage controllers to provide a seamless transfer if one of the physical storage controllers fails.

With this technique of cross wiring storage drives, both of the physical storage controllers can operate simultaneously. However, with this technique neither physical storage controller should operate at greater than half capacity because if one fails the other needs to service the traffic previously serviced by the failed physical storage controller. Accordingly, providing high availability in the context of physical storage controllers unfortunately requires maintaining significantly underutilized physical storage controllers with excess headroom. This is particularly undesirable considering the relatively high cost of these physical storage controllers.

Virtual storage controllers generally require relatively lower cost to implement than physical storage controllers and therefore underutilization is not a significant concern. However, platforms on which virtual storage controllers are implemented may not allow sharing of the same storage drives between virtual storage controllers or, more specifically, the virtual machines on which the virtual storage controllers are executed. Accordingly, high availability solutions possible with physical storage controllers cannot be implemented in cloud or virtualized data storage networks because of this independent operation of the virtual storage controllers.

In addition to the inability to implement high availability solutions possible with physical storage controllers, virtual storage controllers implemented on a cloud data storage platform have other drawbacks. For example, currently virtual storage controllers need to store transaction data (e.g., information regarding write transactions received from clients) on storage server disks prior to the write transactions being committed. Unfortunately, this need for the virtual storage controllers to store the transaction data on disk before they can be acknowledged results in significant write latencies for clients, which is undesirable.

### SUMMARY

A method for facilitating high availability in a storage network includes storing, by a first virtual storage controller executing on a host computing device, a plurality of received transactions in a transaction log in an in-memory storage device. The first virtual storage controller is monitored by the host computing device and a determination is made when a failure of the first virtual storage controller has occurred based on the monitoring. When the failure of the first virtual storage controller is determined to have occurred, at least one storage volume previously assigned to the first virtual storage controller is remapped, by the host computing device, to be assigned to a second virtual storage controller. Additionally, the second virtual storage controller retrieves at least one of the transactions from the transaction log in the in-memory storage device and replays the at least one of the transactions.

A host computing device includes a processor and a memory coupled to the processor which is configured to be capable of executing programmed instructions comprising and stored in the memory to store, by a first virtual storage controller, a plurality of received transactions in a transaction log in an in-memory storage device. The first virtual storage controller is monitored and a determination is made when a failure of the first virtual storage controller has occurred based on the monitoring. When the failure of the first virtual storage controller is determined to have occurred, at least one storage volume previously assigned to the first virtual storage controller is remapped to be assigned to a second virtual storage controller. Additionally, the second virtual storage controller retrieves at least one of the transactions from the transaction log in the in-memory storage device and replays the at least one of the transactions.

A non-transitory computer readable medium having stored thereon instructions for facilitating high availability in a storage network includes executable code which when executed by a processor, causes the processor to perform steps including storing, by a first virtual storage controller, a plurality of received transactions in a transaction log in an in-memory storage device. The first virtual storage controller is monitored and a determination is made when a failure of the first virtual storage controller has occurred based on the monitoring. When the failure of the first virtual storage controller is determined to have occurred, at least one storage volume previously assigned to the first virtual storage controller is remapped to be assigned to a second virtual storage controller. Additionally, the second virtual storage controller retrieves at least one of the transactions from the transaction log in the in-memory storage device and replays the at least one of the transactions.

This technology provides a number of advantages including providing more efficient and effective methods, non-transitory computer readable media, and devices for facilitating high availability in a virtual storage network. With this technology, in-memory storage devices on separate transaction log storage servers are leveraged to store transaction logs for virtual storage controllers in a cloud or virtualized storage network. By using in-memory storage devices, an associated transaction log persists subsequent to the failure of a virtual storage controller. Therefore, another virtual storage controller can efficiently take over for the failed virtual storage controller and replay previously acknowledged transactions, thereby efficiently providing high availability for clients. Additionally, the in-memory storage devices are relatively high speed devices that facilitate efficient acknowledgement of write transactions by the virtual storage controllers, thereby advantageously reducing write latency for clients.

### BRIEF DESCRIPTION OF THE DRAWINGS

FIG. 1 a block diagram of a network environment with an exemplary storage fabric including a plurality of exemplary host computing devices;

FIG. 2 is a block diagram of an exemplary host computing device on which at least two virtual storage controllers are executed;

FIG. 3 is a flowchart of an exemplary method for processing transactions with a virtual storage controller to facilitate high availability; and

FIG. 4 is a flowchart of an exemplary method for providing high availability subsequent to a failure of a virtual storage controller.

### DETAILED DESCRIPTION

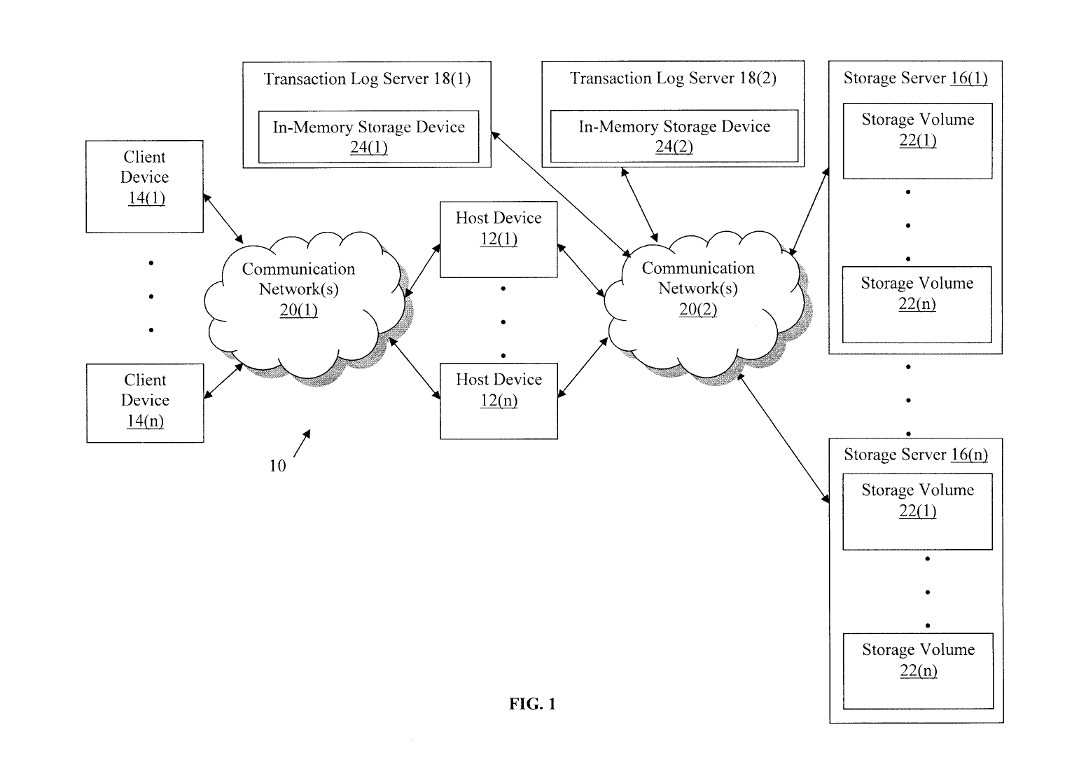

A network environment 10 including a storage fabric with exemplary host computing devices 12(1)-12(n) is illustrated in FIG. 1. The environment 10 in this example further includes client devices 14(1)-14(n), storage servers 16(1)-16(n), and transaction log servers 18(1) and 18(2), although this environment 10 can include other numbers and types of systems, devices, components, and/or elements in other configurations, such as multiple numbers of each of these apparatuses and devices. The client computing devices 14(1)-14(n) are in communication with the host computing devices 12(1)-12(n) through the communication network(s) 20(1) and the host computing devices 12(1)-12(n) are in communication with the storage servers 16(1)-16(n) and the transaction log servers 18(1) and 18(2) through communication network(s) 20(2). This technology provides a number of advantages including methods, non-transitory computer readable medium, and devices that relatively efficiently provide and facilitate high availability of virtual storage controllers in a cloud or virtualized data storage platform.

Each of the client devices 14(1)-14(n) in this example includes a processor, a memory, a network interface, an input device, and a display device, which are coupled together by a bus or other communication link, although each of the client devices 14(1)-14(n) can have other types and numbers of components or elements and other numbers and types of network devices could be used. The client devices 14(1)-14(n) may run interface applications that provide an interface to make requests for and send content and/or data to the host computing devices 12(1)-12(n) via the communication network(s) 20(1), for example. Each of the client devices 14(1)-14(n) may be, for example, a conventional personal computer, a workstation, a smart phone, a virtual machine running in a cloud, or other processing and/or computing device.

Each of the storage servers 16(1)-16(n) in this example includes a plurality of storage volumes 22(1)-22(n), a processor, and a network interface coupled together by a bus or other communication link. The storage volumes 22(1)-22(n) in this example can be hosted by one or more storage devices (not shown) of the storage servers 16(1)-16(n). The storage devices can include conventional magnetic disks, solid-state drives (SSDs), or any other type of stable, non-volatile storage device suitable for storing large quantities of data. One or more of the storage volumes 22(1)-22(n) can span storage devices in one or more of the storage servers 16(1)-16(n) and the storage volumes 22(1)-22(n) can each be mapped to a virtual storage controller, as described and illustrated in more detail later.

In one example, the storage volumes 22(1)-22(n) can be Elastic Block Storage (EBS) volumes provided by a storage network platform available from Amazon.com, Inc. of Seattle, Wash., although the storage volumes 22(1)-22(n) can be any other types of storage volume or organization of data hosted by the storage servers 16(1)-16(n). The storage servers 16(1)-16(n) may be organized into one or more volumes of Redundant Array of Inexpensive Disks (RAID), although other types and numbers of storage servers in other arrangements can also be used.

Each of the transaction log servers 18(1) and 18(2) includes a processor, a memory, and a network interface coupled together by a bus or other communication link. The memory in each of the transaction log servers 18(1) and 18(2) includes an in-memory storage device 24(1) and 24(2), respectively. One or more of the in-memory storage devices 24(1) and 24(2) can be an in-memory cache or an in-memory database, for example. In one example, the in-memory storage devices 24(1) and 24(2) are in-memory caches of the ElastiCache web service product available from Amazon.com, Inc. of Seattle, Wash., although the in-memory storage devices 24(1) and 24(2) can be any other type of in-memory storage device on any other type of data storage platform.

The in-memory storage devices 24(1) and 24(2) are each configured to store a plurality of transaction logs, each associated with one or more virtual storage controller and are used by virtual storage controllers to store information associated with transactions received from the client devices 14(1)-14(n), for example, although the transaction logs can also be used to store other information received from other sources, as described and illustrated in more detail later. Optionally, the transaction log server 18(2) can be configured to replicate the transactions logs in the in-memory storage device 24(1) such that the in-memory storage device 24(2) stores a copy of the transaction logs, thereby providing a backup in the event the transaction log server 18(1) fails. In other examples, other numbers and types of transaction log servers 18(1) and 18(2) can be provided in the network environment 10.

The host computing devices 12(1)-12(n) in this example operate on behalf of the client devices 14(1)-14(n) to store and manage files or other units of data stored by the storage servers 16(1)-16(n). Accordingly, the host computing devices 12(1)-12(n) manage the storage servers 16(1)-16(n) in this example and receive and respond to various read and write requests from the client devices 14(1)-14(n) directed to data stored in, or to be stored in, the storage servers 16(1)-16(n).

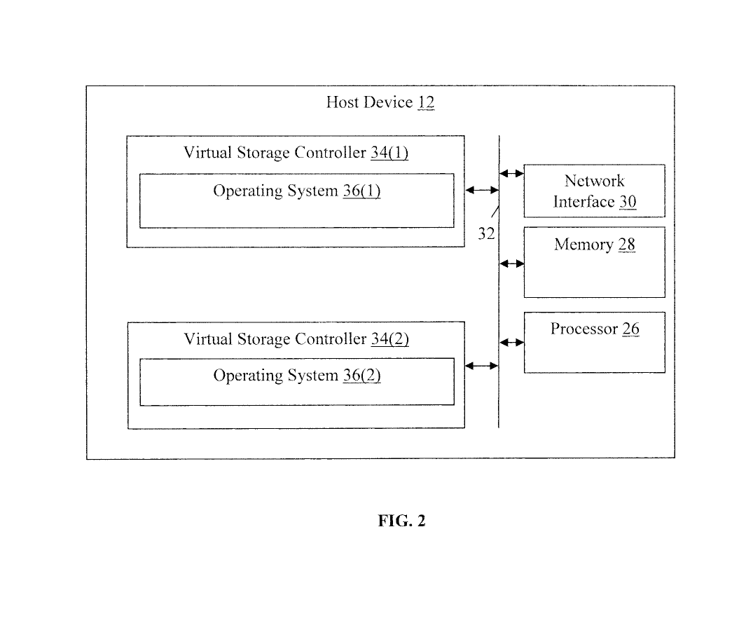

Referring more specifically to FIG. 2, a block diagram of one of the exemplary host computing devices 12(1)-12(n) is illustrated. In this example, the host computing device 12 includes a processor 26, a memory 28, and at least one network interface 30, coupled together by a bus 32 or other communication link. The host computing device 12 further includes a virtual storage controller 34(1) and 34(2), although in other examples additional virtual storage controllers may be executing on the host computing device 12 at any time.

The processor 26 of the host computing device 12 may execute programmed instructions stored in a memory 28 for various functions and/or operations illustrated and described herein. The memory 28 of the host computing device 12 may include any of various forms of read only memory (ROM), random access memory (RAM), Flash memory, non-volatile, or volatile memory, or the like, or a combination of such devices for example. The memory 28 can store instructions comprising a host operating system that, when executed by the processor 26, generates a hypervisor that interfaces hardware of the host computing device 12 with the virtual storage controllers 34(1) and 34(2), such as through virtual machine(s), for example, although the virtual storage controllers 34(1) and 34(2) can be executed and implemented in other manners.

In this example, the virtual storage controller 34(1) currently services traffic associated with the storage and retrieval of data stored by one or more of the storage servers 16(1)-16(n). Optionally, the virtual storage controller 34(2) is also active and currently servicing network traffic, is instantiated but passive, or is spawned upon a failure of the virtual storage controller 34(1), as described and illustrated in more detail later. Each of the virtual storage controllers 34(1) and 34(2) in this example has an associated operating system 36(1) and 36(2), respectively.

The network interface 30 of the host computing device 12 in this example can include a plurality of network interface controllers (NICs), for example, each associated with a respective one of the virtual storage controllers 34(1) and 34(2), for operatively coupling and communicating between the host computing device 12, the client devices 14(1)-14(n), and the storage servers 16(1)-16(n), which are coupled together by the communication network(s) 20(1) and 20(2), although other types and numbers of communication networks or systems with other types and numbers of connections and configurations to other devices and elements also can be used.

By way of example only, the communication network(s) 20(1) and/or 20(2) can use TCP/IP over Ethernet and industry-standard protocols, including NFS, CIFS, SOAP, XML, LDAP, and SNMP, although other types and numbers of communication networks, can be used. The communication network(s) 20(1) and 20(2) in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication network(s) 20(1) and 20(2) may also comprise any local area network and/or wide area network (e.g., Internet), although any other type of traffic network topologies may be used.

Although examples of the host computing device 12, client devices 14(1)-14(n), storage servers 16(1)-16(n), and transaction log servers 18(1) and 18(2) are described herein, it is to be understood that the devices and systems of the examples described herein are for exemplary purposes, as many variations of the specific hardware and software used to implement the examples are possible, as will be appreciated by those skilled in the relevant art(s). In addition, two or more computing systems or devices can be substituted for any one of the systems in any embodiment of the examples.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology, as described and illustrated with the examples herein.

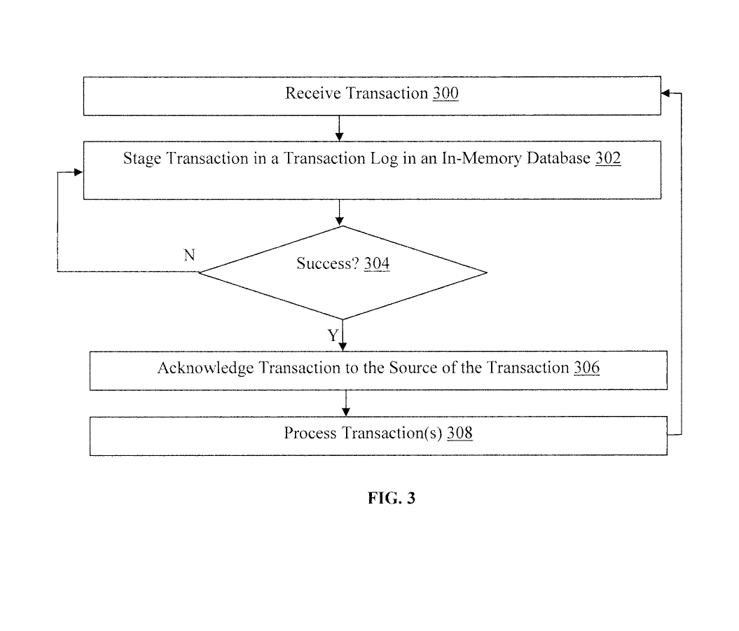

An exemplary method for facilitating high availability in a virtualized cloud data storage platform environment will now be described with reference to FIGS. 1-4. Referring more specifically to FIG. 3, an exemplary method for processing transactions with a virtual storage controller to facilitate high availability is illustrated. In step 300 in this example, the virtual storage controller 34(1) executing on the host computing device 12 receives a transaction, such as from one of the client devices 14(1)-14(n), for example, although the transaction can also be internally generated by the host computing device 12 and/or received from another source. Exemplary transactions can include requests from one of the client devices 14(1)-14(n) to read or write data, although other types and/or numbers of transactions can be received in step 300.

In step 302, the virtual storage controller 34(1) stages the transaction by storing the transaction in a transaction log associated with the virtual storage controller 34(1) in the in-memory storage device 24(1) of the transaction log server 18(1). The transactions are staged because they may be received more quickly than the transactions can be processed by the virtual storage controller 34(1). Generally, processing the transactions using the storage servers 16(1)-16(n) requires a relatively long period of time considering the mechanical nature of the operation of storing and retrieving data on disks of the storage servers 16(1)-16(n).

Optionally, the virtual storage controller 34(1) makes a determination as to whether to stage the transaction according to the type of the transaction. For example, the virtual storage controller 34(1) may stage all write transactions so as to maintain integrity of the data in the event of a failover. In another example, read transactions may not be staged by the virtual storage controller 34(1) since the read request does not effect any stored data and the one of the client devices 14(1)-14(n) in this example will simply reissue the read request in the event of a failure.

In step 304, the virtual storage controller 34(1) determines whether the transaction was successfully stored in the in-memory storage device 24(1) of the transaction log server 18(1). Accordingly, the transaction log server 18(1) can be configured to send an acknowledgement or confirmation of the storage of the transaction. In this example, the virtual storage controller 34(1) can determine that the transaction was not successfully stored in the transaction log in the in-memory storage device 24(1) if the acknowledgement is not received within a predetermined amount of time. In other examples, other methods of determining whether the transaction is successfully stored can also be used.

If the virtual storage controller 34(1) determines that the transaction was not successfully stored, then the No branch is taken back to step 302 and the virtual storage controller 34(1) again attempts to store the transaction in this example. In other examples, the virtual storage controller 34(1) can temporarily store the transaction in another location, retry the storage of the transaction after a specified period of time, or notify the one of the client devices 14(1)-14(n) that the received transaction has failed, for example, although other action can also be taken by the virtual storage controller 34(1) when the virtual storage controller 34(1) determined that the transaction was not successfully stored in the in-memory storage device 24(1).

However, if the virtual storage controller 34(1) determines that the transaction was successfully stored in the in-memory storage device 24(1), then the Yes branch is taken to step 306. In step 306, the virtual storage controller 34(1) acknowledges the transaction to the source of the transaction, such as the one of the client devices 14(1)-14(n) in this example. Accordingly, the virtual storage controller 34(1) can forward an acknowledgement received from the transaction log server 18(1) or send a different acknowledgement message via the communication network(s) 20(1) to the one of the client devices 14(1)-14(n), for example.

By staging the transaction in the in-memory storage device 24(1), client write latency can be significantly reduced. In this example, the transaction can be acknowledged to the one of the client devices 14(1)-14(n) more quickly than if the virtual storage controller 24(1) either staged the transaction on a disk in one of the storage servers 16(1)-16(n) or only acknowledged the transaction subsequent to the transaction being successfully processed.

In step 308, the active virtual storage controller 34(1) executing on the host computing device 12 processes the transaction received in step 300, such as by retrieving requested data from one or more of the storage servers 16(1)-16(n) and/or writing data to one or more of the storage servers 16(1)-16(n), for example. Subsequent to processing the transaction and/or in parallel with any of steps 302-308, the virtual storage controller 34(1) receives a new transaction in step 300.

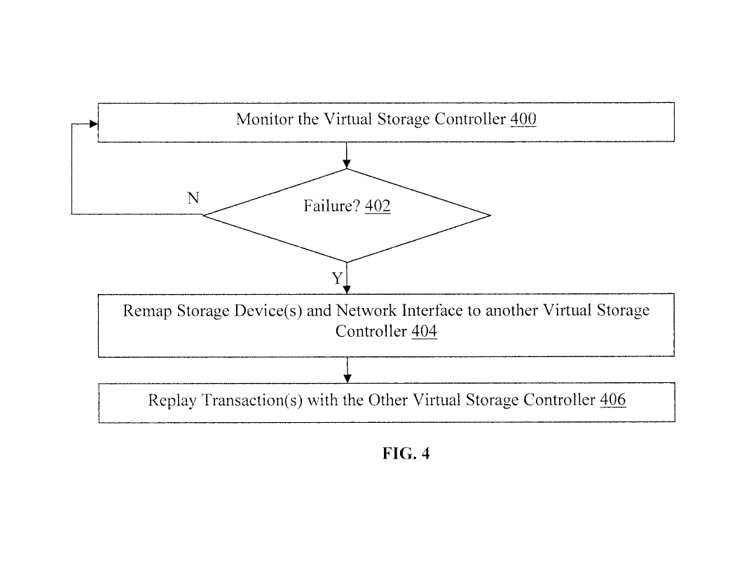

Referring more specifically to FIG. 4, an exemplary method for providing high availability subsequent to a failure of a virtual storage controller is illustrated. In step 400 in this example, the host computing device 12 monitors the virtual storage controller 34(1). The monitoring can be based on a ping or heartbeat signal periodically sent from the virtual storage controller 34(1) to the virtual storage controller 34(2) utilizing a monitoring service executing on the host computing device 12, for example.

In examples in which a monitoring service of the host computing device 12 is used, the virtual storage controller 34(1) can be configured to periodically initiate a heartbeat signal or the monitoring service can periodically send a message using an interconnect or other communication link to prompt the virtual storage controller 34(1) to send the heartbeat signal. Optionally, the heartbeat signal can include a unique identifier for the virtual storage controller 34(1) which is used by the monitoring service to identify the virtual storage controller 34(1), as described and illustrated in more detail later. Any other methods of monitoring or otherwise determining the health of the virtual storage controller 34(1) can also be used.

In step 402, the host computing device 12 determines whether the virtual storage controller 34(1) has entered a failure state. In this example, the host computing device 12 can determine whether the virtual storage controller 34(1) has failed based on whether it has received a heartbeat signal within a specified period of time since a prior heartbeat signal. In another example, the virtual storage controller 34(1) is configured to communicate to the virtual storage controller 34(2) or a monitoring service of the host computing device 12 that it has entered a failure state. Other methods of determining that the virtual storage controller 34(1) has failed can also be used.

In this example, the virtual storage controller 34(1) is executed by the same host computing device 12 and using the same hypervisor as the virtual storage controller 34(2). Accordingly, the failure is of the operating system 36(1). However, in examples in which the virtual storage controller 34(1) and the virtual storage controller 34(2) are executed by different ones of the host computing devices 12(1)-12(n), as described and illustrated in more detail later, the failure could also be a hypervisor or hardware failure, for example. If the host computing device 12 determines that the virtual storage controller 34(1) has not failed, then the No branch is taken back to step 400 and the host computing device 12 continues to monitor the virtual storage controller 34(1), as described and illustrated earlier.

However, if the host computing device 12 determines in step 402 that a failure of the virtual storage controller 34(1) has occurred, then the Yes branch is taken to step 404. In step 404, the host computing device 12 remaps one or more of the storage volumes 22(1)-22(n) previously assigned to the virtual storage controller 34(1) to be assigned to the virtual storage controller 34(2). Accordingly, the storage volumes 22(1)-22(n) in this example are configured to persist subsequent to the failure of the virtual storage controller 34(1) so that the associated data stored in the storage volumes 22(1)-22(n) can be accessed by the virtual storage controller 34(2). In the example in which the storage volumes 22(1)-22(n) are EBS volumes, the storage volumes 22(1)-22(n) can be configured with a delete-on-termination attribute set to false, although other methods of configuring the storage volumes 22(1)-22(n) such that the storage volumes 22(1)-22(n) persist can also be used in other examples.

In one example, in order to remap the storage volumes 22(1)-22(n), the virtual storage controller 34(2) can make call(s) to an application programming interface (API) supported by the cloud platform provider, for example. In another example, the host computing device 12, instead of the virtual storage controller 34(2), can be configured to remap the storage volumes 22(1)-22(n). Other methods of remapping the one or more of the storage volumes 22(1)-22(n) can also be used.

In some examples, the host computing device 12 also remaps the network interface 30, or more specifically a network interface controller (NIC) of the network interface 30, previously assigned to the virtual storage controller 34(1) to be associated with the virtual storage controller 34(2). By remapping the NIC, applications associated with the client devices 14(1)-14(n) previously communicating with the operating system 36(1) of the virtual storage controller 34(1) can communicate with the operating system 36(2) of the virtual storage controller 34(2). The NIC can be remapped using call(s) to the API provided by the cloud platform provider. Alternatively, the remapping can be accomplished through IP address translation of the traffic received from one or more of the client devices 14(1)-14(n), as managed by one or more of the operating systems 36(1) and/or 36(2), for example, although other methods of remapping the NIC can also be used.

The virtual storage controller 34(2) is illustrated in this example as an active or passive virtual storage controller executing on the host computing device 12 or a new virtual storage controller spawned by the host computing device 12 upon the host computing device 12 determining that a failure of the virtual storage controller 34(1) has occurred in step 402. However, in other examples, the virtual storage controller 34(2) can be an active or passive virtual storage controller executing on a different one of the host computing devices 12(1)-12(n). In yet other examples, the virtual storage controller 34(2) can be a new virtual storage controller spawned by another of the host computing devices 12(1)-12(n) upon the host computing device 12 determining that a failure of the virtual storage controller 34(1) has occurred.

In examples in which the virtual storage controller 34(2) is an active or passive virtual storage controller executing on another of the host computing devices 12(1)-12(n), or is newly spawned by another of the host computing devices 12(1)-12(n), the host computing device 12 can be configured to communicate the occurrence of the failure of the virtual storage controller 34(1) to the other of the host computing devices 12(1)-12(n) via the communication networks 20(2), for example, although other methods of communicating the failure can also be used. By executing the virtual storage controller 34(2) on a different one of the host computing devices 12(1)-12(n) than the failed virtual storage controller 34(2) is executed, the storage platform can provide high availability in the event of a hypervisor failure or a failure of hardware of the host computing device 12, in addition to a failure of the operating system 36(1).

In step 406, the virtual storage controller 34(2) replays the transactions stored in the transaction log associated with the failed virtual storage controller 34(1) in the in-memory storage device 24(1) and effectively assumes the role of the failed virtual storage controller 34(1). In some examples, the virtual storage controller 34(2) is provided a unique identifier of the failed virtual storage controller 34(1), such as the identified included in the heartbeat, which is used to identify the transaction log in the in-memory storage device 24(1) from which the transactions are to be replayed.

With this technology, high availability of virtual storage controllers can be provided on a cloud or virtualized data storage network without requiring replication of data and associated cost and while also reducing client write latencies. By storing transaction logs in relatively fast in-memory storage devices on external transaction log servers, client write latency is reduced and a virtual storage controller can advantageously accesses a transaction log utilized by a failed virtual storage controller and replay the associated transactions. Additionally, by remapping the storage volumes previously assigned to the failed virtual storage controller, another virtual storage controller can advantageously assume the role of the failed virtual storage controller with limited disruption to clients associated with the storage network.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for facilitating high availability in a storage network, the method comprising:
storing, by a first virtual storage controller executing on a host computing device, a plurality of received transactions in a transaction log in an in-memory storage device;
monitoring, by the host computing device, the first virtual storage controller; and
determining, by the host computing device, when a failure of the first virtual storage controller has occurred based on the monitoring and when the failure of the first virtual storage controller is determined to have occurred:
remapping, by the host computing device, at least one storage volume previously assigned to the first virtual storage controller to be assigned to a second virtual storage controller;
retrieving, by the second virtual storage controller, at least one of the transactions from the transaction log in the in-memory storage device; and
replaying, by the second virtual storage controller, the at least one of the transactions.

2. The method of claim 1, wherein the in-memory storage device comprises an in-memory cache or an in-memory database and is hosted by a transaction log storage server that is separate from the host computing device and accessible over at least one communication network by the first virtual storage controller and the second virtual storage controller.

3. The method of claim 1, wherein:
the second virtual storage controller is executing on the host computing device or another host computing device; or
the method further comprises spawning, by the host computing device or the other host computing device, the second virtual storage controller.

4. The method of claim 1, wherein the at least one storage volume is configured to persist when the failure of the first virtual storage controller is determined to have occurred.

5. The method of claim 1, further comprising:
determining, by the first virtual storage controller, when each of the transactions is successfully stored in the in-memory storage device; and
acknowledging, by the first virtual storage controller, each of the transactions to a source of each of the transactions when each of the transactions is determined to have been successfully stored in the in-memory storage device.

6. A host computing device comprising a processor and a memory coupled to the processor which is configured to be capable of executing programmed instructions comprising and stored in the memory to:
store by a first virtual storage controller a plurality of received transactions in a transaction log in an in-memory storage device;
monitor the first virtual storage controller;
determine when a failure of the first virtual storage controller has occurred based on the monitoring and when the failure of the first virtual storage controller is determined to have occurred:
remap at least one storage volume previously assigned to the first virtual storage controller to be assigned to a second virtual storage controller;
retrieve, by the second virtual storage controller, at least one of the transactions from the transaction log in the in-memory storage device; and
replay, by the second virtual storage controller, the at least one of the transactions.

7. The host computing device of claim 6, wherein the in-memory storage device comprises an in-memory cache or an in-memory database and is hosted by a transaction log storage server that is separate from the host computing device and accessible over at least one communication network by the first virtual storage controller and the second virtual storage controller.

8. The host computing device of claim 6, wherein:
the second virtual storage controller is executing on the host computing device or another host computing device; or
the processor coupled to the memory is further configured to be capable of executing at least one additional programmed instruction comprising and stored in the memory to spawn the second virtual storage controller.

9. The host computing device of claim 6, wherein the at least one storage volume is configured to persist when the failure of the first virtual storage controller is determined to have occurred.

10. The host computing device of claim 6, wherein the processor coupled to the memory is further configured to be capable of executing programmed instructions further comprising and stored in the memory to:
determine, by the first virtual storage controller, when each of the transactions is successfully stored in the in-memory storage device; and
acknowledge, by the first virtual storage controller, each of the transactions to a source of each of the transactions when each of the transactions is determined to have been successfully stored in the in-memory storage device.

11. A non-transitory computer readable medium having stored thereon instructions for facilitating high availability in a storage network comprising executable code which when executed by a processor, causes the processor to perform steps comprising:
storing, by a first virtual storage controller, a plurality of received transactions in a transaction log in an in-memory storage device;
monitoring the first virtual storage controller; and
determining when a failure of the first virtual storage controller has occurred based on the monitoring and when the failure of the first virtual storage controller is determined to have occurred:
remapping at least one storage volume previously assigned to the first virtual storage controller to be assigned to a second virtual storage controller;
retrieving, by the second virtual storage controller, at least one of the transactions from the transaction log in the in-memory storage device; and
replaying, by the second virtual storage controller, the at least one of the transactions.

12. The non-transitory computer readable medium of claim 11, wherein the in-memory storage device comprises an in-memory cache or an in-memory database and is hosted by a transaction log storage server that is accessible over at least one communication network by the first virtual storage controller and the second virtual storage controller.

13. The non-transitory computer readable medium of claim 11, wherein:
the second virtual storage controller is executing on the host computing device or another host computing device; or
the executable code when executed by the processor further causes the processor to perform at least one additional step comprising spawning the second virtual storage controller.

14. The non-transitory computer readable medium of claim 11, wherein the at least one storage volume is configured to persist when the failure of the first virtual storage controller is determined to have occurred.

15. The non-transitory computer readable medium of claim 11, wherein the executable code when executed by the processor further causes the processor to perform steps further comprising:
determining, by the first virtual storage controller, when each of the transactions is successfully stored in the in-memory storage device; and
acknowledging, by the first virtual storage controller, each of the transactions to a source of each of the transactions when each of the transactions is determined to have been successfully stored in the in-memory storage device.
